(19) United States
(12) Patent Application Publication
(10) Pub. No.: US 2005/0047503 A1
(43) Pub. Date: Mar. 3, 2005

(54) Scalable video coding method and apparatus using pre-decoder

(75) Inventors: Woo-jin Han, Suwon-si (KR); Chang-hoon Yim, Seoul (KR); Ho-jin Ha, Seoul (KR); Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/925,030

(22) Filed: Aug. 25, 2004

Related U.S. Application Data
(60) Provisional application No. 60/497,565, filed on Aug. 26, 2003.

(30) Foreign Application Priority Data
Oct. 22, 2003 (KR) 2003-0073952

(51) Int. Cl. H04N 7/12

(52) U.S. Cl. 375/240.01; 375/240.12

(57) ABSTRACT

A method and an apparatus for controlling bitrates in an optimal manner by use of information available for use by the pre-decoder, in wavelet-based scalable video coding art using the pre-decoder. A method for controlling bitrates includes the steps of determining the amount of bits for each coding unit relative to a bitstream generated by encoding an original image so as to minimize distortion of the final image from the original image, and extracting a bitstream having the target amount of bits by truncating a part of the generated bitstream based on the determined amount of bits.

### BACKGROUND OF THE INVENTION

This application claims priority of U.S. Provisional Patent Application No. 60/497,565 filed on Aug. 26, 2003 in the United States Patent and Trademark Office and Korean Patent Application No. 10-2003-0073952 filed on Oct. 22, 2003 in the Korean Intellectual Property Office, the disclosures of which are herein incorporated by reference.

1. Field of the Invention

The present invention relates to video coding arts, and more particularly, to a method and apparatus for controlling bitrates in an optimal manner by use of information available for use by a pre-decoder, in wavelet-based scalable video coding art using the pre-decoder.

2. Description of the Related Art

It has been well-known that R-D performance (rate-distortion performance) of video coding techniques can be improved significantly by using sophisticated rate control algorithms. Most of the known techniques have utilized some useful information generated in an encoding phase to allocate an adequate number of bits to each coding unit in an optimal rate-distortion sense. In wavelet-based scalable video coding, one large bitstream is generated by an encoder, and a pre-decoder or transcoder can truncate it to have arbitrary size thanks to an embedding principle. When the bitstream is compressed by an encoding method following the embedding principle, data can be restored even though a part of the bitstream is truncated. But, when the bitstream is compressed by other encoding methods not following the embedding principle, data cannot be restored if a part of the bitstream is truncated in an arbitrary manner from the large bitstream generated by the encoder.

This property makes scalable video coders naturally suited to use a rate control algorithm: however, conventional rate control algorithms utilizing some information usable only in encoders cannot be applied directly since actual bit allocation should be made only after the encoding phase in scalable video coders. In this regard, there is a need to create a separate rate control algorithm suitable for the scalable video coder.

Scalable video coding, allowing partial decoding at a variety of resolutions, quality and temporal levels obtained from a single compressed bitstream, is widely considered as a promising technology for efficient signal representation and transmission in heterogeneous environments from low quality video conferencing in a mobile phone to high quality movie playback from digital storage media. Herein, the temporal level refers to the respective frame numbers per second when the frame number per second is different from that of the original data.

There are many approaches to achieve scalability in the video coding technology. Although MPEG-4 FGS (Fine Granularity Scalability) has been established as SNR (sound to noise ratio) and temporal scalable video coding standards, it has been demonstrated that many wavelet-based scalable video coding schemes have their potential for SNR, spatial, and temporal scalability. The term “temporal” refers to some frames among plural frames arranged based on time, and the term “spatial” refers to a part of a frame.

Motion compensated embedded zeroblock coding(MC-EZBC) is a fully scalable video coding system using a 3-D subband/wavelet transformation that exploits both temporal correlation by motion compensated temporal filtering (MCTF) and spatial correlation by wavelet transform. For detailed information about the MC-EZBC, you may refer to ‘Highly scalable subband/wavelet image and video coding’ (Rensselaer Polytechnic Institute, New York, January 2002), a doctoral paper of S.-T. Hsiang.

A recent experimental result shows that MC-EZBC has outperformed MPEG-4 FGS in almost all test conditions. In MC-EZBC, a group of pictures (GOP), which commonly include 16 or 32 frames, are transformed by the invertible motion compensated temporal filters along all motion trajectories. The filtered frames are further decomposed by the wavelet transformation to exploit spatial redundancies and coded by an embedded zeroblock coding (EZBC) algorithm whereas a motion vector code stream is encoded by combinations of a DPCM (Differential Pulse Code Modulation) and an arithmetic coding.

Due to the embedding property of EZBC algorithm, the bitstream of MC-EZBC can be truncated at any point without significant perceptible distortion. The embedding property greatly simplifies rate control because a control parameter is the allocated bitrate for each coding unit rather than the quantization step size usually used in hybrid coders. Compared with rate control for MPEG, research on rate control relative to embedded wavelet video coders has been relatively small. P.-Y. Cheng proposed a rate control scheme derived by means of rate-distortion performance of an embedded wavelet coder, and frame dependency between a reference and a predictive frame in his paper, ‘Rate control for an embedded wavelet video coder’ (IEEE Trans. Circuits Syst. Video Technol., vol. 7, no. 4, pp. 696-702, August 1997). In addition, Caetano further improved Mr. Cheng' work by use of a piecewise linear rate-distortion model, in ‘Rate control strategy for embedded wavelet video coders’ (Electronics Letters, vol. 35, no. 21, pp. 1815-1817, October 1999). And, H. J. Lee proposed rate-distortion based on an optimization technique for zerotree entropy wavelet coding, in ‘Scalable rate control for MPEG-4 video’ (IEEE Trans. Circuits Syst. Video Technol., vol. 10, pp. 878-894, September 2000). Most rate-distortion optimization methods utilize some useful information available in an encoder, such as mean absolute difference (MAD), mean squared error (MSE), and peak signal-to-noise ratio (PSNR).

FIG. 1 is a block diagram illustrating an overall configuration of a video codec based on a rate-distortion optimization technique. Referring to this figure, a rate control module 130 chooses an optimal quantizer step or an amount of optimal bits relative to each coding unit based on a bitrate 30, a user's target rate, and an encoder 110 generates bandwidth-limited bitstream 40 adaptive to limited communication conditions, by encoding original moving pictures based on the quantization step or the optimal bit amount. Then, a decoder 120 recovers image sequences from bandwidth-limited bitstream 40 and outputs the moving picture 20 decompressed. Under the conventional art, the rate-control is performed only in the encoder 110.

A rate control process based on a target bitrate 30 performed in the rate control module 130 will be described in more detail. In this regard, it is assumed that the source statistics have Lagrangian distribution. If we use a difference function as a distortion measure, then there is a close form solution [Equation 1] for the rate distortion function, where D indicates a distortion rate generated in data compression and is computed by a difference between an original image and a final image decompressed.

$$R ( D ) = ln ( \frac{1}{α D} ) \qquad [ 1 ]$$

Many rate-distortion optimization techniques are based on a quadratic rate distortion function, which is a simplified form of Equation [1], defined as
R(i)=aQ(i)⁻¹+bQ(i)⁻² [2]
where a and b are model parameters, Q(i) is a quantizer index and R(i) is a total number of bits for encoding an ith coding unit. In H. J. Lee's paper, the quadratic R-D function is modified as in Equation [3] by introducing two new parameters: MAD and nontexture overhead.

$$\frac{R ( i ) - H ( i )}{M ( i )} = a {Q ( i )}^{- 1} + b {Q ( i )}^{- 2} \qquad [ 3 ]$$

In Equation [3], H(i) denotes the bits used for header information and motion vectors and M(i) denotes MAD computed using motion-compensated residual for the luminance component. The reason to include MAD into the R-D function is to consider a scene complexity for choosing a quantizer step, since larger steps should be used for high complexity frames and smaller steps for low complexity frames at the same target bit-rate limitation.

The modified R-D function [3] has been adopted as part of MPEG-4 standard. In MPEG-4 verification model 5.1, a and b are found by using data point selections for past frames and linear regression analysis, M(i) is computed from motion compensation block, and finally the target quantizer index Q(i) is found. After finding Q(i), the model parameters are updated according to the information of current frame. Although the rate control algorithm used in MPEG-4 has been efficient to improve R-D performance, some changes should be done to apply it to scalable video coding framework using a pre-decoder.

FIG. 2 is a block diagram illustrating an operation structure of wavelet-based scalable video codec according to a conventional art.

Conventional rate control algorithms have generally improved R-D performance, but all of the conventional methods have utilized prediction error information only usable in encoding phase, which implies that the rate control should be done in an encoder 210. For most applications that require fully scalable video coders, the encoder 210 should generate a sufficiently large bitstream 35 and a pre-decoder or transcoder 220 extracts a bitstream 40 having an adequate number of bits by truncating a part of bits from the bit stream 35, in consideration of quality, temporal, and spatial requirements. Then, a decoder 230 can recover a video sequence 20 from the bitstream 40 and display a moving picture 20 decompressed.

Also referring to FIG. 2, the rate control should be done in the pre-decoder 220 instead of the encoder 210, because the actual bit-rate is determined in the pre-decoder 220. However, there has been little research on rate control algorithms in the pre-decoder 220; instead, a constant bit-rate (CBR) scheme (refer to Mr. S.-T. Hsiang's paper) has generally been used. Thus it is valuable to discuss rate control algorithm utilizing information only available in the pre-decoder.

### SUMMARY OF THE INVENTION

The present invention has been conceived to solve the problems described above. An aspect of the present invention is to provide a new rate control algorithm using information useable only in the pre-decoder, in order to enhance the performance of a wavelet-based scalable video coder.

Another aspect of the present invention is to provide a method for enhancing rate-distortion performance by allotting an optimal amount of bits to each coding unit, instead of allotting the same amount of bits to the respective coding units.

Further another aspect of the present invention proposes to allow the rate control algorithm to be applied to all of the wavelet-based scalable video coding techniques.

Consistent with an aspect of the present invention, there is provided a method for controlling bitrates, comprising the steps of determining the amount of bits for each coding unit relative to a bitstream generated by encoding an original image so as to minimize distortion of the final image from the original image, and extracting a bitstream having the target amount of bits by truncating a part of the generated bitstream based on the determined amount of bits.

To obtain the bit amount for the coding unit defined by use of a scene complexity function and the distortion of the final frame from the original frame, the determination step preferably comprises the steps of determining the scene complexity function by use of bit distribution according to the number of bit planes per coding unit, and determining the amount of the bits per coding unit with the use of a method to minimize the distortion of the final frame from the original frame.

The bit amount R(i) relative to the coding unit is defined as

$$\frac{R ( i )}{M ( i )} = ln ( \frac{1}{α D ( i )} ) ,$$

where the number of planes K* whereby the total number of encoded bits is B_{T} is determined by using an extrapolation scheme, relative to accumulated encoded bits B(i,k) using k bit planes, and the scene complexity function M(i) is replaced with B(i,k), and an expression R(i) of that D(i)² is minimum in the rate-distortion function to which the computed is applied,

$$\frac{R ( i )}{B ( i , {K}^{*} )} = ln ( \frac{1}{α D ( i )} ) ,$$

and R(i) having the optimal bit allocation by applying a limitation of

$${\sum }_{i = 1}^{N} R ( i ) = {B}_{T}$$

is obtained.

Consistent with another aspect of the present invention, there is provided a method for scalable video coding, comprising the steps of generating a bitstream by encoding an original moving picture, determining a scene complexity function by using bit distribution according to the number of bit planes of the generated bitstream, the determination being made by representing the generated bitstream by encoding the original moving picture as the scene complexity function relative to the bit amount per coding unit so that the distortion of the final frame from the original moving picture is minimized, and extracting the bitstream having the target amount of bits by truncating a part of the generated bitstream based on the determined bit amount.

The method further comprises the step of recovering and decompressing image sequences of the original moving picture from the extracted bitstream.

Consistent with a further aspect of the present invention, there is provided an apparatus for controlling bitrates, comprising a means for determining the amount of bits per coding unit by encoding an original image so that the distortion of the final frame from the original image is minimum, and a means for extracting a bitstream having the target amount of bits by truncating a part of the generated bitstream based on the determined bit amount.

Consistent with a still further aspect of the present invention, there is provided an apparatus for scalable video coding, comprising an encoder generating a bitstream by encoding an original moving picture, a rate control module determining a scene complexity function by using bit distribution according to the number of bit planes of the generated bitstream, the determination being made by representing the generated bitstream by encoding the original moving picture as the scene complexity function relative to the bit amount per coding unit so that the distortion of the final frame from the original moving picture is minimized, and a pre-decoder extracting the bitstream having the target amount of bits by truncating a part of the generated bitstream based on the determined bit amount.

The apparatus may further comprise a decoder recovering and decompressing image sequences of the original moving picture from the extracted bitstream.

Consistent with a still further aspect of the present invention, there is provided a storage medium storing thereon a wavelet-based scalable video coding method by use of a pre-decoder, which is readable by a computer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an overall configuration of video codec based on a rate-distortion optimization technique;

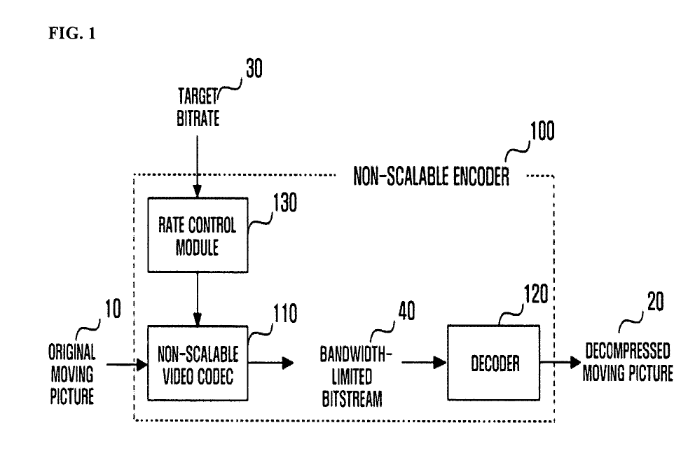

FIG. 2 is a block diagram illustrating an operation structure of a wavelet-based scalable video codec according to a conventional art;

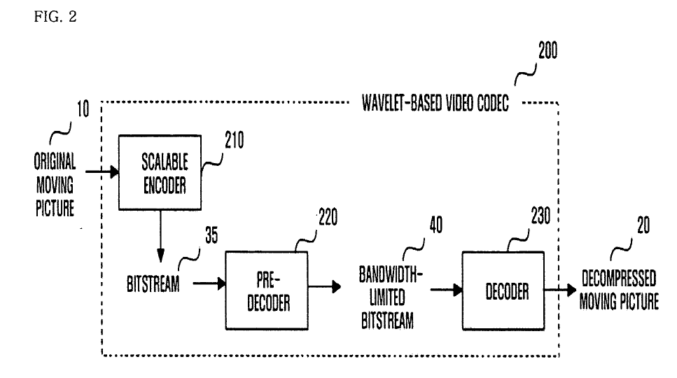

FIG. 3 is a block diagram illustrating an operation structure of a wavelet-based scalable video codec according to the present invention;

FIG. 4 is a view illustrating bit distribution relative to foreman QCIF sequence;

FIG. 5 is a view illustrating M(i) and B(I, K*) where a is 0.156;

FIG. 6 is a view illustrating texture bitrate relative to football QCIF;

FIG. 7 is a view illustrating GOP-average PSNR relative to football QCIF;

FIG. 8A is a flow chart illustrating the overall operation of the present invention; and

FIG. 8B is a flow chart illustrating detailed substeps of Step S820 depicted in FIG. 8A.

### DETAILED DESCRIPTION OF AN EXEMPLARY EMBODIMENT

Hereinafter, an exemplary embodiment of the present invention will be described in detail with reference to the accompanying drawings.

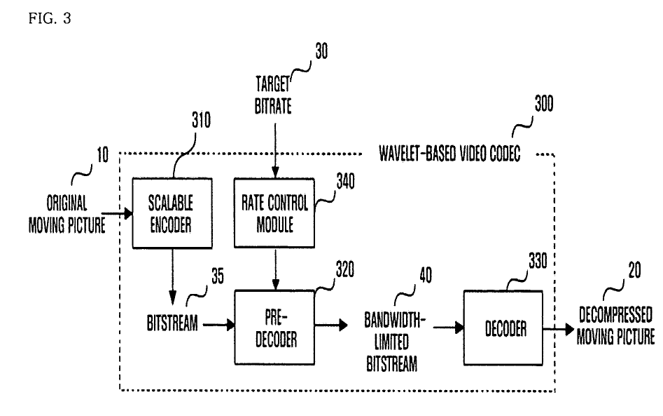

FIG. 3 is a block diagram illustrating an operation structure of a wavelet-based scalable video codec according to the present invention. Referring to this figure, a scalable encoder 310 generates a sufficiently large bitstream 35 by encoding an original moving picture and a rate control module 340 selects optimal amounts of bits for respective coding units based on a user's target bitrate 35. A pre-decoder 320 receives the bitstream 35 input and extracts a bit stream 40 having an adequate amount of bit stream by truncating a part of the bitstream 35 based on the optimal amount of bits selected by the rate control module 340. Then, the decoder 330 recovers an image sequence of the original moving picture from the extracted bitstream 40 and decompresses it. Subsequently, the original moving picture finally decompressed is generated.

The present invention is specifically focused on an operation in the rate control module 340. The operation in the rate control module 340 comprises three processes: definition of a rate-distortion function for a pre-decoder, scene complexity function modeling using information from the pre-decoder, and derivation of a new rate control function to minimize the distortion by use of the rate-distorting function for the pre-decoder. The present invention employs a scene complexity function, which replaces MAD (mean absolute difference) information useable only in an encoder according to a conventional art with bit distribution on bitplane of the same number.

First, the process for defining a rate-distortion function will be described.

It is supposed that a video transmitted can be partitioned into multiple coding units with each GOP having multiple frames, that is, groups-of-pictures (GOPs), whereby respective frames existing in the GOPs are heavily correlated due to the MCTF process whereas a rate control algorithm can be simplified because respective GOPs are separately encoded and independent of one another. For a starting point, we modify the R-D function of Equation [1] to have scene complexity parameter M(i) in Equation [4],

$$\frac{R ( i )}{M ( i )} = ln ( \frac{1}{α D ( i )} ) \qquad [ 4 ]$$

where R(i), M(i), and D(i) are a total number of bits, scene complexity parameter, and average difference between one frame and the final frame decompressed by the decoder, for the ith GOP (coding unit), respectively. For the notational simplicity, the nontexture overhead, H(i), is not considered in Equation [4] and other equations in this specification since it has a trivial effect. Supposing that B_{T} is the total bits for an entire video sequence that consists of N GOPs, Equation [5] is obtained.

$${\sum }_{i = 1}^{N} R ( i ) = {B}_{T} \qquad [ 5 ]$$

Now, the rate-control problem can be formulated as

$$\{ R ( 1 ) , … , R ( N ) \} = arg {min}_{\{ R ( 1 ) , … , R ( N ) \}} {\sum }_{i = 1}^{N} {D ( i )}^{2} \qquad [ 6 ]$$

where the right side thereof means that R(1) or R(N) is selected so as to allow D(i)² to have the minimum value under the conditions of Equations [4] and [5]. Mean squared error (MSE) is used for distortion measure in (6). It is very clear that computation of R(i) in Equation [6] requires two parameters, M(i) and D(i). Although the mean absolute difference (MAD) is usually used for M(i) in conventional methods, it cannot be used for M(i) in the present invention because it cannot be obtained in a pre-decoder phase knowing no value of the source data. Therefore, we must approximate M(i) with other information available in the pre-decoder.

Second, the process for scene complexity function modeling using bit distribution will be described. An embedded quantization algorithm used for quantizing wavelet coefficients basically consists of two steps: establishment of quadtree representation for individual subbands, and progressive bitplane coding of significant pixels. Progressive bitplane coding can be thought as the successive approximation quantization scheme with threshold 2ⁿ for coefficient bitplane index n. In addition, the number of significant pixels is directly related to the amount of allocated bits. The higher the number of significant pixels is, the more bits are required to encode them and vice versa.

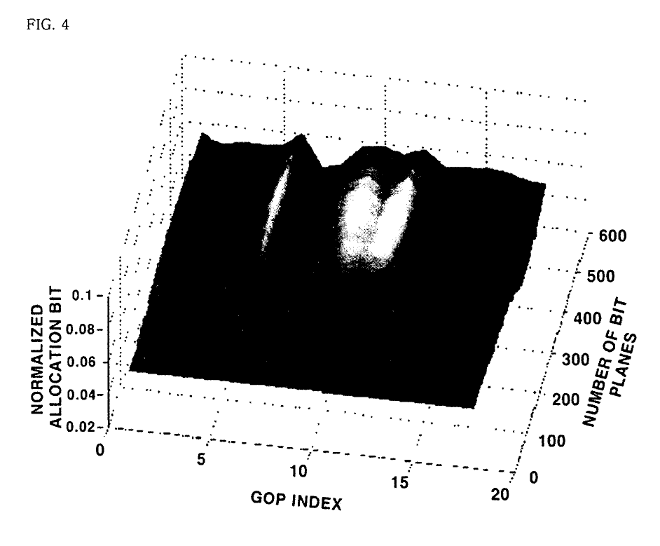

FIG. 4 is a view illustrating bit distribution relative to foreman QCIF sequence. In this figure, the gray intensity means an amount of total allocated bits for a GOP index and the number of used bitplanes, wherein the lighter it is, the higher the number of bits is. To illustrate the relative strength clearly, the gray intensity is normalized by the sum for all GOPs at a given number of bitplanes. As shown in the figure, it is clear that the number of allocated bits varies significantly for different GOP indexes (GOPs gradual arrangement relative time) with the same number of bitplanes. If we define a scene complexity as how difficult it is to encode a given image frame, an amount of allocated bits for a GOP at the same number of bitplanes is strongly correlated to the relative scene complexity among GOPs.

Supposing that B(i, k) is the accumulated encoded bits using k bitplanes and that the number of used bitplanes is a constant value K for all GOPs, B(i, K) yields some statistics of scene complexity for ith GOP with total allocated bits given by

$$A ( K ) = {\sum }_{i = 1}^{N} B ( i , K ) \qquad [ 7 ]$$

where N is the total number of GOPs. By using a linear interpolation technique, we can obtain more accurate statistics of scene complexity at the exact point where total encoded bits have B_{T}. Supposing that K* is a non-integer number of bitplanes of which total amount of allocated bits is exactly B_{T}, the following equations are obtained.

$$\begin{matrix}B ( i , {K}^{*} ) = Γ ( i , K ) \{ {B}_{T} - A ( K ) \} + B ( i , K ) \\ where & [ 8 ] \\ Γ ( i , K ) = \frac{B ( i , K ) - B ( i , K - 1 )}{A ( K ) - A ( K - 1 )} \\ and , & [ 9 ] \\ A ( K - 1 ) \leq {B}_{T} < A ( K ) & [ 10 ]\end{matrix}$$

To find some relations between the MAD values M(i) and the amount of bits at the same number of bitplanes, B(i, K*), the value of R(i) is fixed to generate a bitstream at 512 kbps for foreman QCIF sequence. D(i) is computed from PSNR values between original and decoded sequences. Furthermore, M(i) is computed from Equation [4].

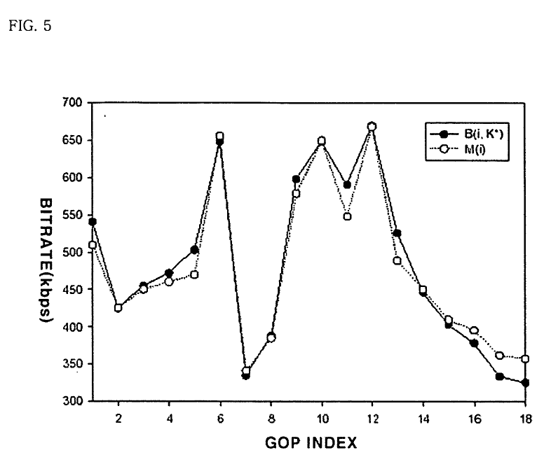

FIG. 5 is a view illustrating M(i) and B(I, K*) where a is 0.156. As shown in the figure, B(i, K*) is well matched to M(i), and thus, B(i, K*) can be used to replace M(i) with an appropriate value of alpha(α). Replacing M(i) in Equation (4) with B(i, K*) yields

$$\frac{R ( i )}{B ( i , {K}^{*} )} = ln ( \frac{1}{α D ( i )} ) \qquad [ 11 ]$$

Third, a process for discovering a rate control algorithm to minimize the distortion will be described. Now, the rate control problem can be solved. The constrained optimization problem as in Equation [6] can be converted to an unconstrained optimization problem by using the Lagrangian method. To use the number of bits for a GOP instead of a frame, Cheng's method is slightly modified. In this case, an object of the present invention can be achieved by minimizing the following equation.

$$J ( R ( 1 ) , … , R ( N ) ) = {\sum }_{i = 1}^{N} {D ( i )}^{2} + λ ( {\sum }_{i = 1}^{N} R ( i ) - {B}_{T} ) \qquad [ 12 ]$$

where R(i) is an allocated bit for ith GOP and D(i) is given by Equation [11]. Since each GOP is processed independently, D(i) only depends on R(i). Thus, at the optimum point, the following equation is obtained.

$$\frac{\partial {D ( i )}^{2}}{\partial R ( i )} + λ = 0 for i = 1 , 2 , … , N \qquad [ 13 ]$$

Rearranging Equation [11] for D(i)² and inserting it to Equation [13] yields the following equation.

$$R ( i ) = - \frac{B ( i , {K}^{*} )}{2} \{ ln \frac{{α}^{2} λ}{2} + ln \frac{B ( i , {K}^{*} )}{2} \} \qquad [ 14 ]$$

Because the sum of R(i) for all GOPs should be B_{T}, the right side of Equation [14] satisfies the following equation:

$$- {\sum }_{i = 1}^{N} \frac{B ( i , {K}^{*} )}{2} \{ ln \frac{{α}^{2} λ}{2} + ln \frac{B ( i , {K}^{*} )}{2} \} = {B}_{T} \qquad [ 15 ]$$

Rearranging Equation [15] and inserting it to Equation [14] yields the optimal bit allocation as in the following equation.

$$\begin{matrix}{R}_{o} ( i ) = B ( i , {K}^{*} ) + \frac{B ( i , {K}^{*} ) β ( i )}{{\sum }_{i = 1}^{N} B ( i , {K}^{*} )} \\ where & [ 16 ] \\ β ( i ) = {\sum }_{i = 1}^{N} \frac{B ( i , {K}^{*} )}{2} ln \frac{B ( i , {K}^{*} )}{2} - ln \frac{B ( i , {K}^{*} )}{2} {\sum }_{i = 1}^{N} \frac{B ( i , {K}^{*} )}{2} & [ 17 ]\end{matrix}$$

It should be noted that two unknown parameters α and λ can be removed simultaneously. Moreover, it can be easily seen that the sum of the second term in the right side of Equation [16] from i=1 to N is zero. Using Equation [16] proposed in the present invention, instead of a constant bit allocation scheme, can improve R-D performance of video coders. In addition, since Equations [16] and [17] are simple summation and computed once per each GOP, the computational complexity imposed for rate control is negligible. [61] Performance of a method proposed in the present invention will be compared with a conventional method through a simulation. A public MC-EZBC implementation (refer to S.-T. Hsiang' paper) is used as a baseline video coder for both methods. As a moving picture source for performance comparison, foreman, football, and canoa sequences of QCIF size at 30 Hz frame rate (FPS: Frame Per Second) are used. After encoding the sequences, bitstreams are generated at bit-rates from 64 kbps to 768 kbps using the pre-decoders using the conventional CBR (refer to S.-T. Hsiang' paper) and two rate control schemes proposed in the present invention.

Table 1 shows average PSNR results using CBR and the proposed rate control scheme. VBR-D is the proposed method minimizing the distortion described.

TABLE 1

| | | |
|---|---|---|
| Bit-rate | | |
| (kbps) | CBR | VBR-D |

Foreman QCIF@30 Hz

| | | |
|---|---|---|
| 64 | 27.57 | 27.72 |
| 128 | 32.30 | 32.50 |
| 256 | 36.40 | 36.72 |
| 384 | 38.91 | 39.19 |
| 512 | 40.73 | 41.04 |
| 768 | 43.63 | 43.86 |

Football QCIF@30 Hz

| | | |
|---|---|---|
| 64 | 21.81 | 21.88 |
| 128 | 25.62 | 25.81 |
| 256 | 28.73 | 28.94 |
| 384 | 30.75 | 31.06 |
| 512 | 32.36 | 32.73 |
| 768 | 35.15 | 35.58 |

Canoa QCIF@30 Hz

| | | |
|---|---|---|
| 64 | 23.43 | 23.48 |
| 128 | 26.34 | 26.39 |
| 256 | 29.26 | 29.34 |
| 384 | 31.39 | 31.45 |
| 512 | 33.27 | 33.37 |
| 768 | 36.31 | 36.40 |

As shown in the above table, the proposed scheme outperforms the convention CBR scheme up to 0.4 dB. In addition, it can be observed that the PSNR improvements are very small at bit-rates of 64 kbps. This tendency is mainly due to a lack of texture information in the very low bit-rate since only texture information is scalable under conventional MC-EZBC.

Table 2 shows standard deviation of PSNR values using CBR and VBR-D.

TABLE 2

| | | | |
|---|---|---|---|
| Bit-rate | | | VBR-D/CBR |
| (kbps) | CBR | VBR-D | (%) |

Foreman QCIF@30 Hz

| | | | |
|---|---|---|---|
| 64 | 2.04 | 1.63 | 80.0 |
| 128 | 2.32 | 1.84 | 79.0 |
| 256 | 2.14 | 1.61 | 75.1 |
| 384 | 1.92 | 1.34 | 70.2 |
| 512 | 1.83 | 1.27 | 69.5 |
| 768 | 1.64 | 1.12 | 68.4 |

Football QCIF@30 Hz

| | | | |
|---|---|---|---|
| 64 | 2.09 | 1.58 | 75.8 |
| 128 | 2.90 | 2.35 | 80.8 |
| 256 | 3.20 | 2.28 | 71.3 |
| 384 | 3.30 | 2.35 | 71.0 |
| 512 | 3.42 | 2.33 | 68.2 |
| 768 | 3.58 | 2.29 | 64.1 |

Canoa QCIF@30 Hz

| | | | |
|---|---|---|---|
| 64 | 1.30 | 1.12 | 86.6 |
| 128 | 1.26 | 1.03 | 81.8 |
| 256 | 1.31 | 1.03 | 78.1 |
| 384 | 1.30 | 0.99 | 75.9 |
| 512 | 1.29 | 0.98 | 76.3 |
| 768 | 1.31 | 1.00 | 76.3 |

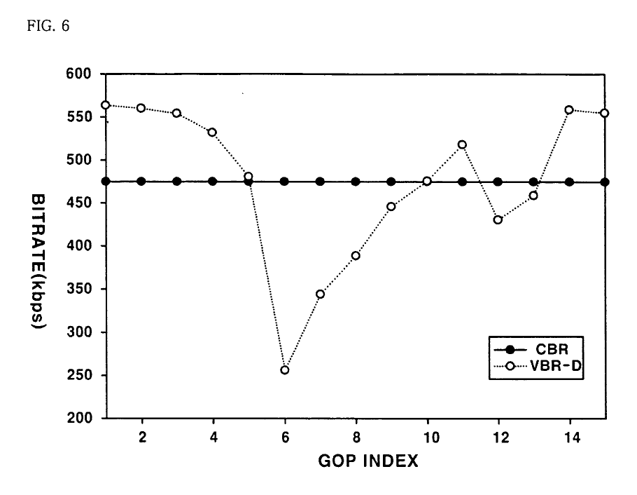

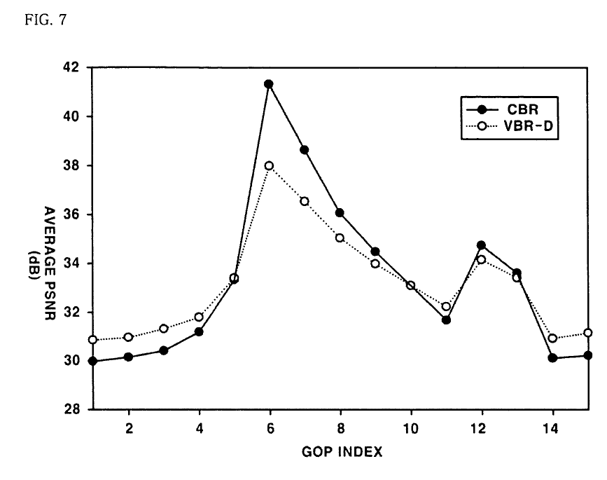

It is clear that the VBR-D can reduce the standard deviation of PSNR curve significantly. VBR-D reduced standard deviation of frame PSNR's by about 25%. FIG. 6 is a view illustrating texture bitrates relative to football QCIF. Football QCIF was encoded at the average bit-rate of 512 kbps. Actual average bit-rates shown in the figure are smaller than the target bit-rate since bit-rates for motion vectors and header information are not included. Moreover, GOP-averaged PSNR instead of frame PSNR is depicted so as to investigate overall flatness of PSNR curve. In FIG. 6, the bit-rates of CBR are almost constant and those of VBR-D are highly variable since they are optimized by scene characteristics, which are highly variable. On the other side, the GOP-averaged PSNR curve of VBR-D is slightly flatter than that of CBR as shown in FIG. 7. This property is very useful to increase subjective visual quality, because the visual quality can be controlled in a more perceptual sense by improving the visual quality of some “too poor” frames with sacrificing that of some “too good”’ frames.

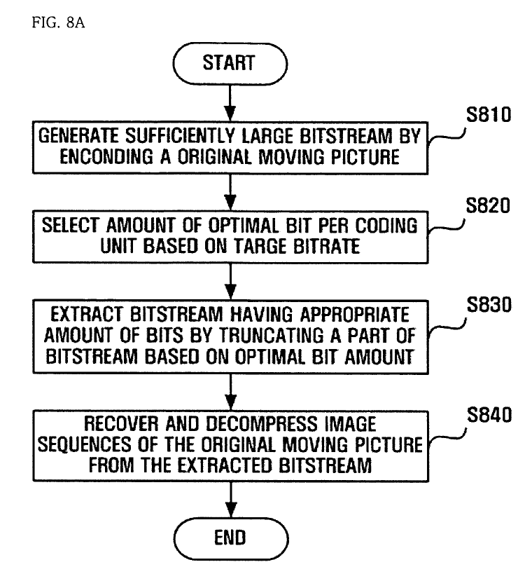

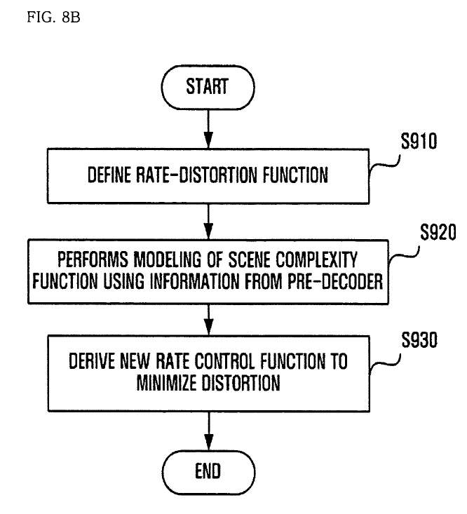

FIG. 8a is a flow chart illustrating the overall operation of the present invention, and FIG. 8b is a flow chart illustrating detailed substeps of Step S820 depicted in FIG. 8a. A scalable encoder 310 generates a sufficiently large bitstream 35 by encoding an original moving picture S810. Then, a rate control module 340 selects the amount of optimal bits for each coding unit based on a user's target bitrate S820.

To describe step S820 in more detail, a rate-distortion function is defined by using the total number of bits per coding unit, scene complexity function, and a difference value between a single frame and the final frame (distortion of the final frame from the single frame) S910. Then, the scene complexity function performs modeling by means of bit distribution according to the coding unit and the number of bit planes, and the scene complexity function having performed the modeling is applied to the rate-distortion function S920. Subsequently, a new rate control function to minimize the distortion is derived with the use of the rate-control function to which the scene complexity function having performed the modeling is applied S930.

The pre-decoder 320 receives the bitstream 35 as input and extracts a bitstream 40 having an appropriate amount of bits by truncating a part of the bitstream 35 based on the new rate control function derived in the rate control module 340, that is, the amount of optimal bits derived S830. Then, the decoder 330 recovers and decompresses the image sequences of an original moving picture from the extracted bitstream 40 S840. Finally the original moving picture decompressed is generated.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects.

As described above, the present invention provides bitstreams having appropriate sizes according to bandwidth variable according to network environment.

In comparison with a rate control method by means of CBR in the pre-decoder, the present invention is more advantageous in that average PSNR of visual scene quality is enhanced up to 0.4 dB.

Further, the rate control algorithm according to the present invention is advantageously applied to all of the wavelet-based scalable video coding technique.

1. A method for controlling bitrates, comprising the steps of:
determining an amount of bits for each coding unit relative to a bitstream generated by encoding an original image so as to minimize distortion of a final image from the original image; and
extracting a bitstream having a target amount of bits by truncating a part of the generated bitstream based on the determined amount of bits.

2. The method as claimed in claim 1, wherein, to obtain the bit amount for the coding unit defined by use of a scene complexity function and the distortion of the final frame from the original frame, the determining step comprises the steps of:
determining the scene complexity function by use of bit distribution according to a number of bit planes per coding unit; and
determining the amount of the bits per coding unit using a method to minimize the distortion of the final frame from the original frame.

3. The method as claimed in claim 2, wherein the bit amount R(i) relative to the coding unit is defined as
$$\frac{R ( i )}{M ( i )} = ln ( \frac{1}{α D ( i )} ) ,$$
where the number of bit planes K*, whereby the total number of encoded bits is B_{T}, is determined by using an extrapolation scheme, relative to accumulated encoded bits B(i,k) using k bit planes, the scene complexity function M(i) is replaced with B(i,k), an expression for R(i) having a minimum value of D(i)² in the rate-distortion function is
$$\frac{R ( i )}{B ( i , {K}^{*} )} = ln ( \frac{1}{α D ( i )} ) ,$$
and R(i) having the optimal bit allocation by applying a limitation of
$${\sum }_{i = 1}^{N} R ( i ) = {B}_{T}$$
is obtained.

4. A method for scalable video coding, comprising the steps of:
generating a bitstream by encoding an original moving picture;
determining a scene complexity function by using bit distribution according to a number of bit planes of the generated bitstream, the determination being made by representing the generated bitstream by encoding the original moving picture as the scene complexity function relative to the bit amount per coding unit so that the distortion of the final frame from the original moving picture is minimized; and
extracting the bitstream having a target amount of bits by truncating a part of the generated bitstream based on the determined bit amount.

5. The method as claimed in claim 4, further comprising the step of recovering and decompressing image sequences of the original moving picture from the extracted bitstream.

6. The method as claimed in claim 4, wherein the bit amount R(i) relative to the coding unit is defined as
$$\frac{R ( i )}{M ( i )} = ln ( \frac{1}{α D ( i )} ) ,$$
where the number of bit planes K*, whereby the total number of encoded bits is B_{T}, is determined by using an extrapolation scheme, relative to accumulated encoded bits B(i,k) using k bit planes, the scene complexity function M(i) is replaced with B(i,k), an expression R(i) having a minimum value of D(i)² in the rate-distortion function is
$$\frac{R ( i )}{B ( i , {K}^{*} )} = ln ( \frac{1}{α D ( i )} ) ,$$
and R(i) having the optimal bit allocation by applying a limitation of
$${\sum }_{i = 1}^{N} R ( i ) = {B}_{T}$$
is obtained.

7. The method as claimed in claim 6, wherein the expression R(i) having the minimum value of D(i)² is obtained by use of Lagrangian method.

8. An apparatus for controlling bitrates, comprising:
an encoder for determining an amount of bits per coding unit by encoding an original image so that a distortion of a final frame from the original image is minimum; and
an extractor for extracting a bitstream having a target amount of bits by truncating a part of a generated bitstream based on the determined bit amount.

9. The apparatus as claimed in claim 8, wherein, to obtain the bit amount for the coding unit defined by use of a scene complexity function and the distortion of the final frame from the original frame, the encoder comprises:
a scene complexity determiner for determining the scene complexity function by use of bit distribution according to a number of bit planes per coding unit; and
a coding unit determiner for determining the amount of the bits per coding unit with the use of a method to minimize the distortion of the final frame from the original frame.

10. The apparatus as claimed in claim 9, wherein the bit amount R(i) relative to the coding unit is defined as
$$\frac{R ( i )}{M ( i )} = ln ( \frac{1}{α D ( i )} ) ,$$
where the number of bit planes K*, whereby the total number of encoded bits is B_{T}, is determined by using an extrapolation scheme, relative to accumulated encoded bits B(i,k) using k bit planes, the scene complexity function M(i) is replaced with B(i,k), an expression R(i) having a minimum of D(i)² in the rate-distortion function is
$$\frac{R ( i )}{B ( i , {K}^{*} )} = ln ( \frac{1}{α D ( i )} ) ,$$
and R(i) having the optimal bit allocation by applying a limitation of
$${\sum }_{i = 1}^{N} R ( i ) = {B}_{T}$$
is obtained.

11. An apparatus for scalable video coding, comprising:
an encoder generating a bitstream by encoding an original moving picture;
a rate control module determining a scene complexity function by using bit distribution according to a number of bit planes of the generated bitstream, the determination being made by representing the generated bitstream by encoding the original moving picture as the scene complexity function relative to the bit amount per coding unit so that a distortion of a final frame from the original moving picture is minimized; and
a pre-decoder extracting the bitstream having the target amount of bits by truncating a part of the generated bitstream based on the determined bit amount.

12. The apparatus as claimed in claim 11, further comprising a decoder recovering and decompressing image sequences of the original moving picture from the extracted bitstream.

13. The apparatus as claimed in claim 11, wherein the bit amount R(i) relative to the coding unit is defined as
$$\frac{R ( i )}{M ( i )} = ln ( \frac{1}{α D ( i )} ) ,$$
where the number of bit planes K*, whereby the total number of encoded bits is B_{T}, is determined by using an extrapolation scheme, relative to accumulated encoded bits B(i,k) using k bit planes, the scene complexity function M(i) is replaced with B(i,k), an expression R(i) having a minimum value of D(i)² in the rate-distortion function t is
$$\frac{R ( i )}{B ( i , {K}^{*} )} = ln ( \frac{1}{α D ( i )} ) ,$$
and R(i) having the optimal bit allocation by applying a limitation of
$${\sum }_{i = 1}^{N} R ( i ) = {B}_{T}$$
is obtained.

14. The apparatus as claimed in claim 13, wherein the expression R(i) of having the minimum value of D(i)² is obtained by use of Lagrangian method.

15. A storage medium storing thereon a method according to claim 1, which is readable by a computer.
